(19) United States
(12) Patent Application Publication
(10) Pub. No.: US 2024/0300400 A1
(43) Pub. Date: Sep. 12, 2024

(54) COVER ASSEMBLY FOR CARGO AREA OF A FIRE TRUCK

(71) Applicants: Sean O'Brian, Wilson, NC (US); Michael Sumner, Wilson, NC (US)

(72) Inventors: Sean O'Brian, Wilson, NC (US); Michael Sumner, Wilson, NC (US)

(21) Appl. No.: 18/119,003

(22) Filed: Mar. 8, 2023

(51) Int. Cl. B60P 7/04; B60J 7/08

(52) U.S. Cl. CPC B60P 7/04; B60J 7/085

(57) ABSTRACT

A cover assembly for mounting onto a rescue vehicle includes a housing extending between a first end and a second end. The housing includes a first wall, a side wall, and a top wall defining an interior region. A hose reel extends within the interior region of the housing and is coupled with the first end of the housing and the second end of the housing. The hose reel is spring loaded within the housing. A cover is disposed about the hose reel, and the cover includes a bottom end having at least one fastening mechanism configured to engage with the rescue vehicle. The cover is actuated between a stored configuration and a deployed configuration.

### TECHNICAL FIELD

The present disclosure relates to a cargo area of a fire truck, and more particularly to a retractive and removable cover for the cargo area of a fire truck.

### BACKGROUND

It is common for fire trucks to hold a plurality of cargo, accessories, or tools within the fire truck during operation which may be required for use when combatting fires. For example, it is common for fire trucks to have a rear cargo area that holds a plurality of hoses for use in delivering water to distinguish fires. However, since the hoses may be carried at the rear of the fire truck and are often exposed, the hoses may be damaged from weather, sunlight, or other debris. Further, there remains the risk that the hoses fall out of the fire truck during operation. There remains a need for a retractable method for covering the cargo area for protecting and maintaining the position of these accessories within the fire truck. It is also required for this cover to be easily and quickly actuatable to reduce any delays when needing to access the hoses.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In an Example 1, a cover assembly is provided for mounting onto a rescue vehicle. The cover assembly includes a housing extending between a first end and a second end, the housing including a first wall, a side wall, and a top wall defining an interior region; a hose reel extending within the interior region of the housing and coupled with the first end of the housing and the second end of the housing, wherein the hose reel is spring loaded within the housing; a cover disposed about the hose reel, the cover including a bottom end having at least one fastening mechanism configured to engage with the rescue vehicle; and wherein the cover is actuated between a stored configuration and a deployed configuration.

In an Example 2, the cover assembly of Example 1, wherein the rescue vehicle includes a cargo area having an opening and the cover is configured for covering the opening when in the deployed configuration such that the cargo area is enclosed.

In an Example 3, the cover assembly of Example 2, wherein the cargo area is configured for supported a plurality of hoses and when in the deployed configuration, the position of the plurality of hoses within the cargo area is retained.

In an Example 4, the cover assembly of Example 1, wherein the cover assembly includes a mounting plate fixed onto side walls of the cargo area and configured to couple with the housing.

In an Example 5, the cover assembly of Example 4, wherein the mounting plate includes a lip defining a gap, and wherein the housing includes at least one horizontal plate that is received within the gap upon coupling of the housing and the mounting plate.

In an Example 6, the cover assembly of Example 4, wherein the housing is permanently fixed to the mounting plate.

In an Example 7, the cover assembly of Example 4, wherein the housing is reversibly fixed to the mounting plate.

In an Example 8, the cover assembly of Example 1, wherein the cover is composed of a flexible membrane that is weather resistant.

In an Example 9, the cover assembly of Example 1, wherein the rescue vehicle includes a rail extending laterally across the rear end of the rescue vehicle, and wherein the at least one fastening mechanism is coupled with the rail in the deployed configuration.

In an Example 10, a fire truck is provided. The fire truck includes a front end; a rear end; a cargo area at the rear end of the fire truck configured for supporting a plurality of hoses, the cargo area having a first side wall opposite a second side wall and an opening extending therebetween; and a cover assembly coupled with the cargo area of the fire truck. The cover assembly includes: a housing extending between a first end and a second end, the housing including a first wall, a side wall, and a top wall defining an interior region; a hose reel extending within the interior region of the housing and coupled with the first end of the housing and the second end of the housing, wherein the hose reel is spring loaded within the housing; a cover disposed about the hose reel, the cover including a bottom end having at least one fastening mechanism configured to engage with the fire truck; and wherein the cover is actuated between a stored configuration and a deployed configuration.

In an Example 11, the fire truck of Example 10, wherein the cover assembly further includes a first and second mounting plate, the first mounting plate coupled with the first side wall and the second mounting plate coupled with the second side wall.

In an Example 12, the fire truck of Example 11, wherein the first mounting plate and the second mounting plate are permanently coupled with the first side wall and the second side wall, respectively.

In an Example 13, the fire truck of Example 11, wherein each of the first mounting plate and the second mounting plate include a lip defining a gap that is configured for receiving a portion of the housing.

In an Example 14, the fire truck of Example 13, wherein the housing includes a first horizontal plate and a second horizontal plate and wherein the second horizontal plate is at least partially received within the gap.

In an Example 15, the fire truck of Example 10, wherein the cover includes a plurality of fastening mechanisms coupled with the cover such that the fastening mechanisms engage with a rail of the fire truck when the cover is in the deployed configuration.

In an Example 16, the fire truck of Example 13, wherein the hose reel is spring loaded such that the cover is biased into the retracted configuration such that when the engagement between the rail and the fastening mechanisms is released, the cover automatically retracts into the retracted configuration.

In an Example 17, the fire truck of Example 10, wherein the cover is composed of a flexible membrane that is weather resistant.

In an Example 18, a fire truck is provided. The fire truck includes a front end, a rear end, and a cargo area at the rear end of the fire truck configured for supporting a plurality of hoses. The cargo area has a first side wall opposite a second side wall and an opening extending therebetween. A cover assembly is coupled with the cargo area of the fire truck. The cover assembly includes: a housing extending between a first end and a second end, the housing including a first wall, a side wall, and a top wall defining an interior region; a hose reel extending within the interior region of the housing and coupled with the first end of the housing and the second end of the housing, wherein the hose reel is spring loaded within the housing; at least one mounting plate coupled with the cargo area, the at least one mounting plate coupled with the housing; a cover disposed about the hose reel, the cover including a bottom end having at least one fastening mechanism configured to engage with the fire truck; and wherein the cover includes a retracted configuration and a deployed configuration, wherein the hose reel biases the cover to the retracted configuration and wherein when in the deployed configuration, a plurality of fastening mechanisms are coupled with the cargo area such that the cover is maintained in the deployed configuration.

In an Example 19, the fire truck of Example 18, wherein the at least one mounting plate includes a lip defining a gap that is configured for receiving a portion of the housing.

In an Example 20, the fire truck of Example 19, wherein the housing includes a first horizontal plate and a second horizontal plate and wherein the second horizontal plate is at least partially received within the gap.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

FIG. 1 is a perspective view of an exemplary rescue vehicle, in accordance with embodiments of the present disclosure.

FIG. 2 illustrates a rear view of an exemplary rescue vehicle having a cargo area, in accordance with embodiments of the present disclosure.

FIG. 3 illustrates a rear perspective view of the cargo area of FIG. 2, in accordance with embodiments of the present disclosure.

FIG. 4 illustrates a rear view of the cargo area of FIG. 2 after enclosure by a cover assembly, in accordance with embodiments of the present disclosure.

FIG. 5 illustrates a rear view of the cargo area of FIG. 2 after enclosure by a cover assembly, in accordance with embodiments of the present disclosure.

FIG. 6 illustrates a cross sectional schematic view of a cover assembly, in accordance with embodiments of the present disclosure.

FIG. 7 illustrates a top perspective view of a portion of a cover assembly, in accordance with embodiments of the present disclosure.

FIG. 8 illustrates a top perspective view of a portion of the cover assembly of FIG. 7, in accordance with embodiments of the present disclosure.

FIG. 9 illustrates a top perspective view of a portion of a cover assembly, in accordance with embodiments of the present disclosure.

FIG. 10 illustrates a top view of a mounting plate for use with a cover assembly, in accordance with embodiments of the present disclosure.

FIG. 11 illustrates a cross sectional view of a portion of a cover assembly, in accordance with embodiments of the present disclosure.

### DETAILED DESCRIPTION

Various aspects of the disclosure are described more fully below with reference to the accompanying Appendix, which forms a part hereof, and which show specific example aspects. However, different aspects of the disclosure may be implemented in many different ways should not be construed as limited to the aspects set forth herein. The following detailed description is, therefore, not to be taken in a limiting sense.

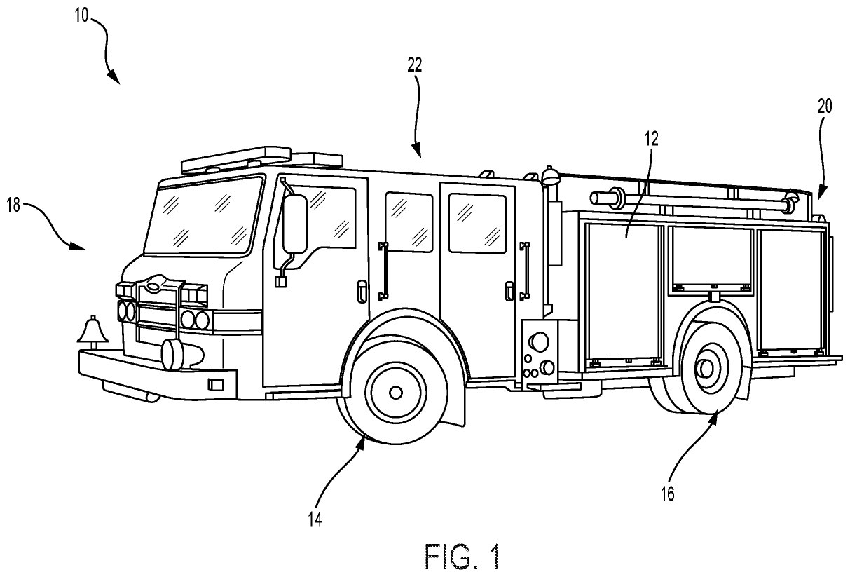

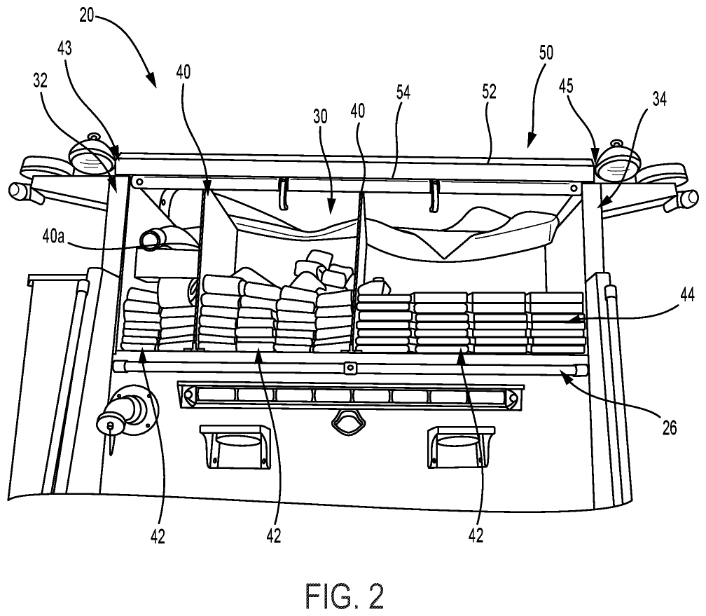

FIG. 1 illustrates a front side perspective view of a rescue vehicle, and more particularly a fire truck 10. As illustrated, the fire truck includes a main frame 12 supported by front ground engaging members 14 and rear ground engaging members 16. The fire truck 10 additionally includes a front end 18 and a rear end 20. The front end 18 includes an operator area 22 which includes at least a driver's seat such that an operator may control the operation of the fire truck 10. In use, it is often desired to support a plurality of accessories and cargo when operating the fire truck 10. For example, a ladder, hoses, or various other accessories may be carried within the fire truck 10 for use to distinguish a fire and must be supported during both transport and prior to use. With reference now to FIGS. 2-10, the rear end 20 of the fire truck 10, and more particularly storage options within the f10, will be described further.

For example, FIG. 2 illustrates an enlarged rear perspective view of the rear end 20 of the fire truck 10 and more particularly, a cargo area 30 defining the rear end 20 of the fire truck 10. As illustrated, cargo area 30 is defined by a first side wall 32 opposite a second side wall 34, a rear wall (not shown), and a floor panel 36. As illustrated, the first and second side walls 32, 34 and floor panel 36 define an opening 38, which may have a rectangular shape and through which stored cargo may be visible. In some embodiments, the cargo area 30 includes a plurality of panels 40, illustratively a first panel 40a and a second panel 40b, which extend upwardly from the floor panel 36 to split the cargo area 30 into a plurality of compartments 42. Further, the rear end 20 of the fire truck 10 includes a rail 26 extending laterally across the rear end 20 of the fire truck 10 and vertically below the opening 38.

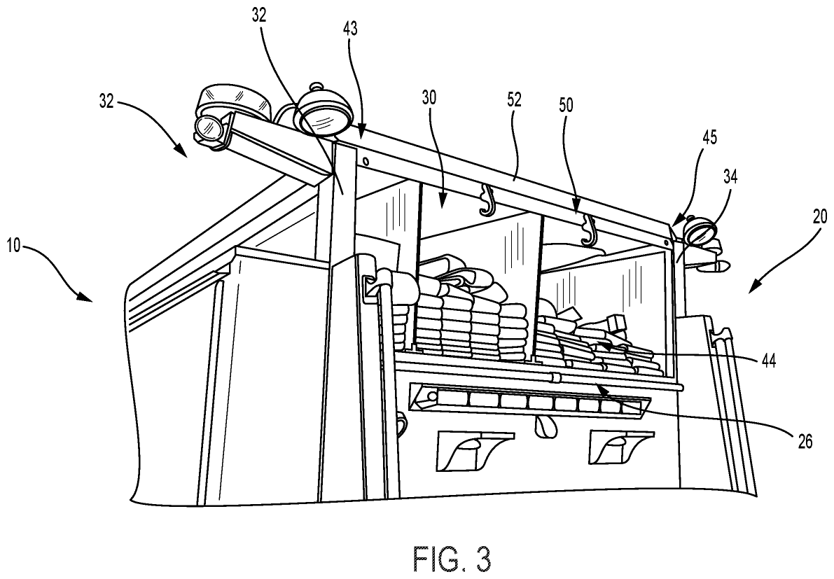

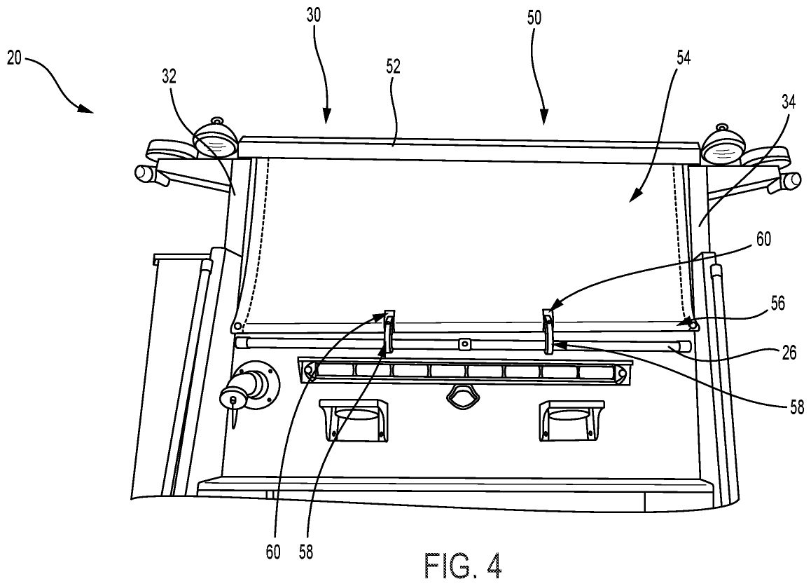

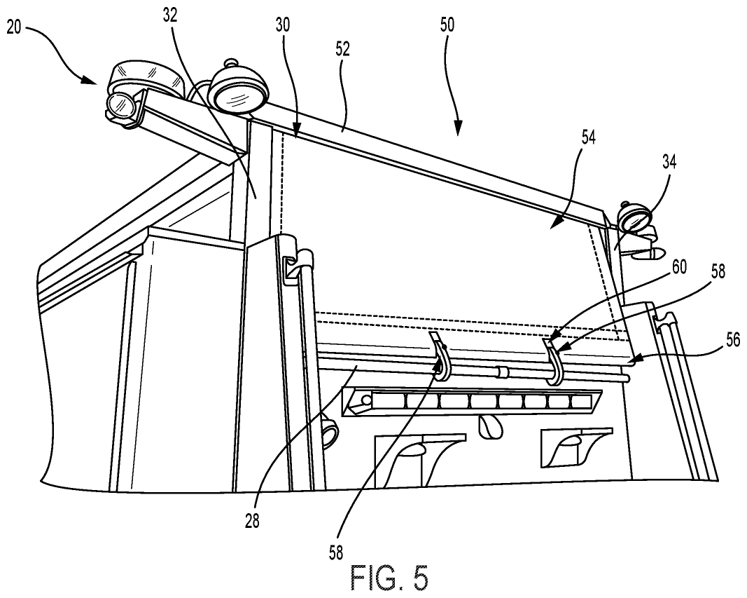

As illustrated, the plurality of compartments 42 may be used for storing various cargo and tools. For example, as illustrated in FIG. 2, the plurality of compartments 42 support a plurality of hoses 44. Additionally, further accessories may be supported, for example a tarp, rope or other various cargo that is required for transport within the fire truck 10. During operation of the fire truck 10, it may be desired for the cargo area 30 to be enclosed at the rear end 20 of the fire truck 10 so that the cargo, illustratively the plurality of hoses 44, do not fall out of the fire truck 10. Therefore, fire truck 10 further includes a cover assembly 50 for reversibly enclosing the cargo area 30. FIGS. 2-3 illustrate the cover assembly 50 in a retracted configuration such that the cargo is not enclosed while FIGS. 4-5 illustrate the cover assembly 50 in a closed and deployed configuration such that the cargo area 30 is enclosed and cargo is secured within the cargo area. The cover assembly 50 will be described further herein.

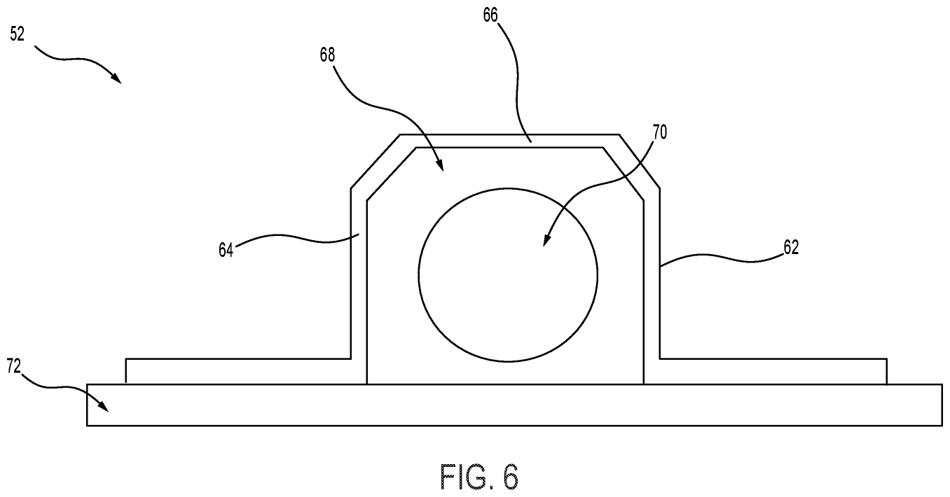

For example, as shown in FIGS. 2-5, the cover assembly 50 includes a housing 52 defined as a rectangular frame having a first end 43 opposite a second end 45. The housing 52 extends laterally between the first side wall 32 and the second side wall 34. The housing 52 is mechanically fastened with the first side wall 32 and the second side wall 34 such that the cover assembly 50 is fixed relative to the first side wall 32 and second side wall 34, as will be described further with reference to FIGS. 6-10. In some embodiments, the cover assembly 50 may be permanently fixed to the first side wall 32 and the second side wall 34; however, in additional embodiments, the cover assembly 50 may be reversibly coupled with the first side wall 32 and the second side wall 34 such that the housing 52 is easily removed and reattached to the first side wall 32 and the second side wall 34.

The cover assembly 50 additionally includes a cover 54 that may be reversible housed within the housing 52. The cover 54 acts as a retractable flexible membrane that contains the accessories during transit. In some embodiments, the cover 54 may be composed of plastic, rubber, netting, vinyl, mesh, a flexible membrane, fabric straps, or various other flexible materials. Further, it may be desired for the cover 4 to be composed of weather-proof materials so that the cover 54 may be exposed to the external environment while still maintain intact. Additionally, the cover 54 may also protect the cargo accessories from sunlight.

FIGS. 2-3 illustrate the cover 54 in the retracted configuration such that the cover 54 fits within the housing 52 with the exception of a bottom end 56 of the cover 54. FIGS. 4-5 illustrate the cargo area 30 with the housing 52 in a closed configuration. In other words, the cover 54 has been pulled vertically downward to cover the entirety of the opening 38 of the cargo area 30. At the bottom end 56 of the cover 54, the cover assembly 50 further includes one or more, illustratively two, fastening mechanisms 58 for engaging the fire truck 10 to secure the cover 54 in the closed configuration. The fastening mechanisms 58 may be, illustratively, hooks, which are engaged within openings 60 of the bottom end 56 of the cover assembly 50 which are configured for engaging with the rail 26 defined just below the opening 38. In this way, an operator may pull down on the cover 54 until the bottom end 56 is positioned vertically low enough such that the fastening mechanisms 58 may be engaged with the rail 26. The engagement between the fastening mechanisms 58 and the rail 26 ensure that the cover 54 is maintained in the closed and deployed configuration until further actuation by the operator. Further, while the fastening mechanisms 58 are illustrated as hooks, various other mechanisms may be incorporated. For example, the fastening mechanisms 58 may include grommets, bungee cords, or various other applicable mechanisms for attaching the cover 54 to the rail 26 or other features of the fire truck 10. As a specific exemplary alternative embodiment, the fastening mechanisms 58 may be male or female portions of seat belt buckles, and corresponding female or male portions of the seat belt buckles may be positioned at the rear of the fire truck 10. The cover assembly 50 may additionally include hand straps that are easily accessible for the operator to pull the cover 54 downwards to increase the ease with which the operator may actuate the cover 54. As illustrated in FIGS. 4-5, when the cover 54 is in the closed configuration, the entirety of the opening 38 is enclosed and any cargo retained within the cargo area 30 is inhibited from falling out of the cargo area 30.

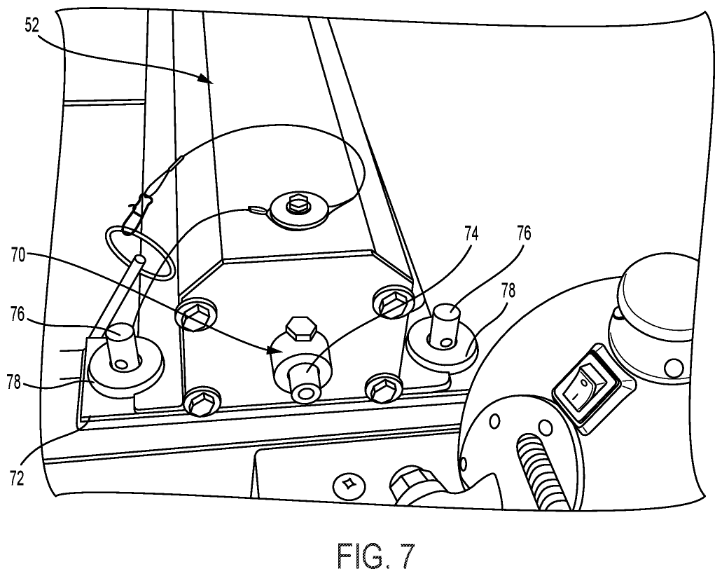

With reference now to FIGS. 6-11, the structure of the cover assembly 50 and the fastening mechanisms 58 will be described further. FIG. 7 illustrates a schematic cross-sectional view of the cover assembly 50. The cover assembly 50 includes the housing 52 having a generally rectangular shape defined by a first side wall 62 opposite a second side wall 64 and a top wall 66 defining an interior region 68. The interior region 68 is configured for housing the cover 54 (FIG. 4) and more particularly, configured for housing the cover 54 disposed about a hose reel 70. The hose reel 70 has a generally circular configuration; however, in further embodiments, the hose reel 70 may have a different cross-sectional profile. Further, the cover assembly 50 includes at least one mounting plate 72 which may be engaged with the housing 52. For example, the at least one mounting plate 72 may include at least two mounting plates such that each end 43, 45 of the housing 52 is coupled with the mounting plates 72. As shown in FIG. 6, the mounting plate 72 has a generally planar configuration and the mounting plate 72 may be fixed with the first side wall 32. While not illustrated, a second mounting plate may be engaged with the second side wall 34.

Further, while not shown, the hose reel 70 may be coupled to the housing 52 such that the hose reel 70 may rotate freely within the housing 52 during the actuator of the cover 54 downwards. More particularly, the hose reel 70 is spring loaded within the housing 52 such that the cover 54 is biased by the hose reel 70 in the rolled and retracted configuration (i.e., the configuration of FIG. 3). In this way, when the operator pulls the cover 54 downwards and couples the fastening mechanisms 58 with the rail 26, the cover 54 is under tension. In this way, when the cover 54 is later released, the spring biases the cover 54 upwards so that it is automatically retracted. However, in other embodiments, other mechanisms may be used for causing this automatic retraction of the cover 54. For example, in some embodiments, an electric or hydraulic assembly may be used with the hose reel 70 to cause this automatic retraction of the cover 54.

The above described coupling between the housing 52 and the hose reel 70 may be permanent. However, in other embodiments, the hose reel 70 and the cover 54 may define a sub-assembly which may be reversibly coupled with the housing 52. In this way, the hose reel 70 and the cover 54 may be coupled with the first side wall 32 and the second side wall 34 and the housing 52 may or may not be incorporated into the design. In the embodiments wherein the hose reel 70 is not permanently fixed with the housing 52, the housing 52 may have a releasable coupling with the first side wall 32 and the second side wall 34 (for example, through coupling with the mounting plate 72 or through direct coupling with the first side wall 32 and the second side wall 34) such that the housing 52 can be easily removed and reattached. For example, the housing 52 may be coupled through quick release clips, cotter pins, tensions clips, clamps, quick release bolts, or any other mechanism that allows for quick removal of the housing 52.

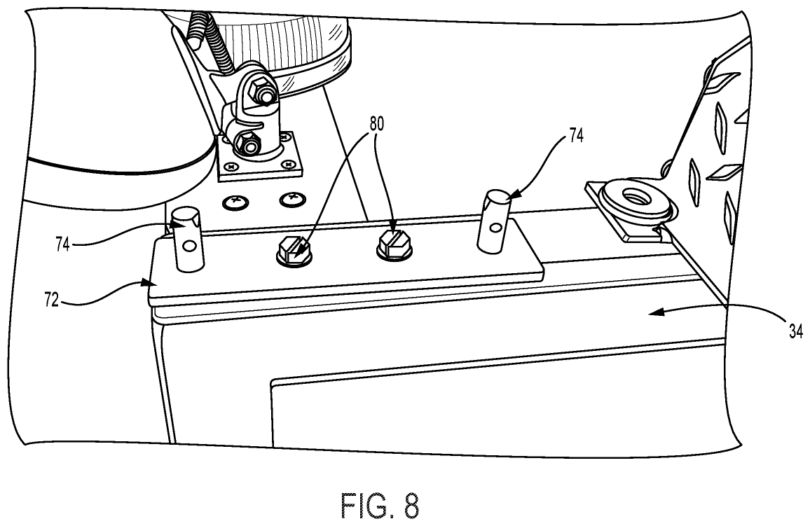

FIG. 7 illustrates a top perspective view of a portion of the cover assembly 50 and more particularly the first end 43 of the housing 52 coupled with the mounting plate 72 and the mounting plate 72 coupled with the first side wall 32 and the second side wall 34. As illustrated, a plurality of posts 76 fixed to and extending upwardly from the mounting plate 72 are configured for receiving washers 78 that are fixed to the housing 52 in order to couple the housing 52 and the mounting plate 72. Additionally, FIG. 7 illustrates an end portion 74 of the hose reel 70 extending outwardly from the housing 52 which may rotate freely relative to the housing 52, as previously described. FIG. 8 illustrates the mounting plate 72 without the housing 52 coupled thereto. More particularly, the mounting plate 72 is coupled to each of the side walls, illustratively the second side wall 34, through the use of fasteners 80 such as bolts. Further, the posts 76 are illustrated extending upwardly from the mounting plate 72 which are configured for receiving the washer 78 fixed with the housing 52. In this way, the housing 52 is fixed to the first side wall 32 and the second side wall 34 through the engagement with the mounting plate 72. However, various other configurations of the cover assembly 50 and more particularly the mounting plate 72 and the housing 52 may be incorporated.

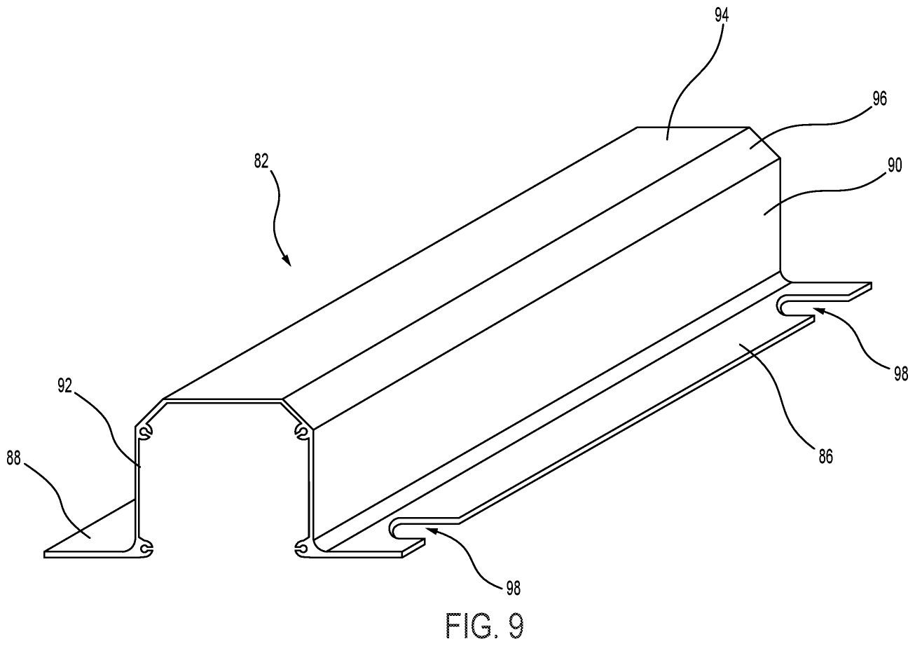

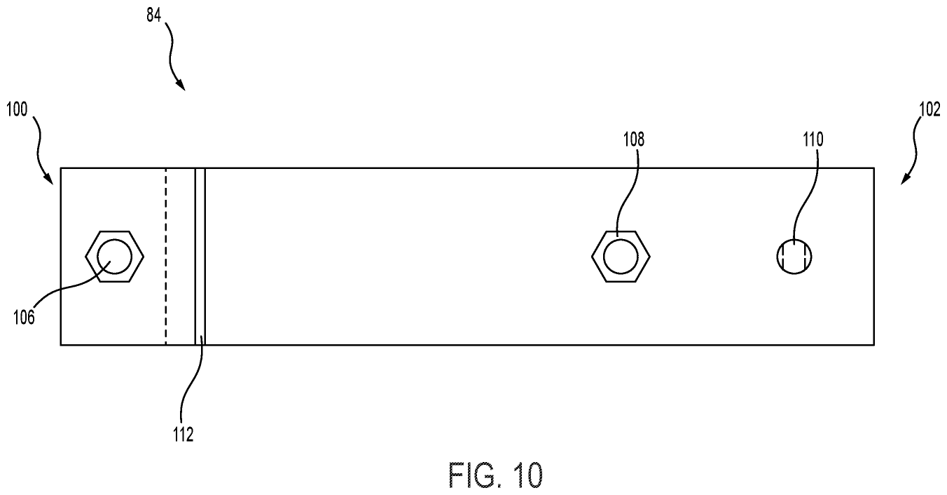

For example, FIGS. 9-11 illustrate an additional embodiment of a housing 82 and a mounting plate 84 for use with the cover 54. For example, the housing 82 is shown in FIG. 9. As illustrated, the housing 82 includes a first horizontal panel 86, a second horizontal panel 88, a first side wall 90 opposite a second side wall 92. The housing 82 further includes a top panel 94 which is coupled with the first side wall 90 and the second side wall 92 through the use of slanted walls 96. Further, the first horizontal panel 86 includes at least two recesses 98 extending partially therein. FIG. 10 illustrates a top view of the mounting plate 84. As illustrated, the mounting plate 84 is generally rectangular in shape and extends between a first end 100 and a second end 102. The mounting plate 84 additionally includes a first fastener 106 extending through the mounting plate 84 adjacent the first end 100 to couple the mounting plate 84 with the first side panel 32. The mounting plate 84 additionally includes a second fastener 108 arranged towards the second end 102 to fix the mounting plate 84 with the first side wall 32. With reference still to FIG. 10, the mounting plate 84 includes an opening 110 which may be aligned with one of the recesses 98 of the housing 82 for coupling the housing 82 with the mounting plate 84. The mounting plate 84 further includes a lip 112 having an upward flare for engaging with the housing 82.

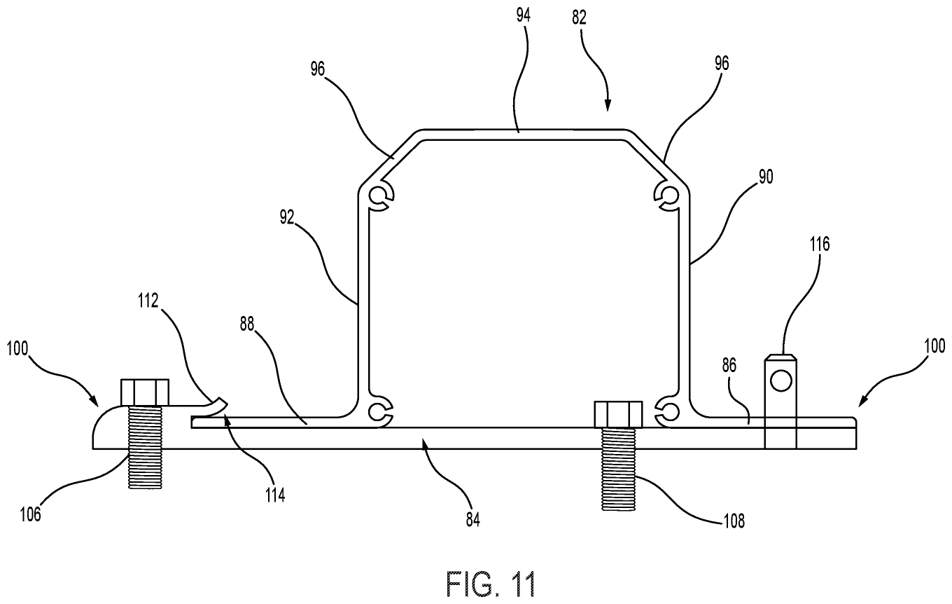

For example, FIG. 11 illustrates a cross-sectional view of the mounting plate 84 coupled with the housing 82. As illustrated, the lip 112 flares upwardly to form a gap 114 which may engage with the second horizontal panel 88 of the housing 82. More particularly, the second horizontal panel 88 may slide into the gap 114 to sit within the lip 112. Further, the opening 110 may align with the recesses 98 of the first horizontal panel 86 to receive a fastener 116 that may extend through the opening 110 and one of the recesses 98 of the first horizontal panel 86. In this way, the mounting plate 84 may be coupled with the housing 82. This embodiment further allows for easily removal for the mounting plate 84 from the housing 82 such that the operator may use the fire truck 10 without having the housing 82 extending laterally across the cargo area 30.

While the cover assembly 50 is described herein as extending generally vertically and providing cover for the storage at the rear end 20 of the fire truck 10, the cover assembly 50 may be incorporated into various different locations of the fire truck 10. For example, the cargo area 30 may also have a cover assembly 50 incorporated such that the cover assembly 50 is actuated horizontally to cover a top surface of the cargo area 30. More particularly, and with reference to FIG. 1, the cover assembly 50 may be coupled to a rear wall of the operator area 22 and be actuated towards the rear end and couple with a rail that extends laterally between the first side wall 32 and the second side wall 34. In this way, the top of the cargo area 30 is also protected from weather, sunlight and debris and may aid in the containment of the cargo within the cargo area 30.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided the description and illustration of the present application, one skilled in art may envision variations, modifications, and alternate aspects falling within the spirit of the broader aspects of the general inventive concept embodied in this application that do not depart from the broader scope of the claimed disclosure.

1. A cover assembly for mounting onto a rescue vehicle, the cover assembly including:
a housing extending between a first end and a second end, the housing including a first wall, a side wall, and a top wall defining an interior region;
a hose reel extending within the interior region of the housing and coupled with the first end of the housing and the second end of the housing, wherein the hose reel is spring loaded within the housing;
a cover disposed about the hose reel, the cover including a bottom end having at least one fastening mechanism configured to engage with the rescue vehicle; and
wherein the cover is actuated between a stored configuration and a deployed configuration.

2. The cover assembly of claim 1, wherein the rescue vehicle includes a cargo area having an opening and the cover is configured for covering the opening when in the deployed configuration such that the cargo area is enclosed.

3. The cover assembly of claim 2, wherein the cargo area is configured for supported a plurality of hoses and when in the deployed configuration, the position of the plurality of hoses within the cargo area is retained.

4. The cover assembly of claim 1, wherein the cover assembly includes a mounting plate fixed onto side walls of the cargo area and configured to couple with the housing.

5. The cover assembly of claim 4, wherein the mounting plate includes a lip defining a gap, and wherein the housing includes at least one horizontal plate that is received within the gap upon coupling of the housing and the mounting plate.

6. The cover assembly of claim 4, wherein the housing is permanently fixed to the mounting plate.

7. The cover assembly of claim 4, wherein the housing is reversibly fixed to the mounting plate.

8. The cover assembly of claim 1, wherein the cover is composed of a flexible membrane that is weather resistant.

9. The cover assembly of claim 1, wherein the rescue vehicle includes a rail extending laterally across the rear end of the rescue vehicle, and wherein the at least one fastening mechanism is coupled with the rail in the deployed configuration.

10. A fire truck having a front end and a rear end, the fire truck including:
a cargo area at the rear end of the fire truck configured for supporting a plurality of hoses,
the cargo area having a first side wall opposite a second side wall and an opening extending therebetween;
a cover assembly coupled with the cargo area of the fire truck, the cover assembly including:
a housing extending between a first end and a second end, the housing including a first wall, a side wall, and a top wall defining an interior region;
a hose reel extending within the interior region of the housing and coupled with the first end of the housing and the second end of the housing, wherein the hose reel is spring loaded within the housing;
a cover disposed about the hose reel, the cover including a bottom end having at least one fastening mechanism configured to engage with the fire truck; and
wherein the cover is actuated between a stored configuration and a deployed configuration.

11. The fire truck of claim 10, wherein the cover assembly further includes a first and second mounting plate, the first mounting plate coupled with the first side wall and the second mounting plate coupled with the second side wall.

12. The fire truck of claim 11, wherein the first mounting plate and the second mounting plate are permanently coupled with the first side wall and the second side wall, respectively.

13. The fire truck of claim 11, wherein each of the first mounting plate and the second mounting plate include a lip defining a gap that is configured for receiving a portion of the housing.

14. The fire truck of claim 13, wherein the housing includes a first horizontal plate and a second horizontal plate and wherein the second horizontal plate is at least partially received within the gap.

15. The fire truck of claim 10, wherein the cover includes a plurality of fastening mechanisms coupled with the cover such that the fastening mechanisms engage with a rail of the fire truck when the cover is in the deployed configuration.

16. The fire truck of claim 13, wherein the hose reel is spring loaded such that the cover is biased into the retracted configuration such that when the engagement between the rail and the fastening mechanisms is released, the cover automatically retracts into the retracted configuration.

17. The fire truck of claim 10, wherein the cover is composed of a flexible membrane that is weather resistant.

18. A fire truck having a front end and a rear end, the fire truck including:
a cargo area at the rear end of the fire truck configured for supporting a plurality of hoses,
the cargo area having a first side wall opposite a second side wall and an opening extending therebetween;
a cover assembly coupled with the cargo area of the fire truck, the cover assembly including:
a housing extending between a first end and a second end, the housing including a first wall, a side wall, and a top wall defining an interior region;
a hose reel extending within the interior region of the housing and coupled with the first end of the housing and the second end of the housing, wherein the hose reel is spring loaded within the housing;
at least one mounting plate coupled with the cargo area, the at least one mounting plate coupled with the housing;
a cover disposed about the hose reel, the cover including a bottom end having at least one fastening mechanism configured to engage with the fire truck; and
wherein the cover comprises a retracted configuration and a deployed configuration, wherein the hose reel biases the cover to the retracted configuration and wherein when in the deployed configuration, a plurality of fastening mechanisms are coupled with the cargo area such that the cover is maintained in the deployed configuration.

19. The fire truck of claim 18, wherein the at least one mounting plate includes a lip defining a gap that is configured for receiving a portion of the housing.

20. The fire truck of claim 19, wherein the housing includes a first horizontal plate and a second horizontal plate and wherein the second horizontal plate is at least partially received within the gap.
